(19) United States
(12) Patent Application Publication
(10) Pub. No.: US 2026/0128191 A1
(43) Pub. Date: May 7, 2026

(54) LOW PFAS INSULATED DATA COMMUNICATIONS CABLE

(71) Applicant: Champlain Cable Corporation, Colchester, VT (US)

(72) Inventors: Robert Konnik, Colchester, VT (US); Richard Trahan, Colchester, VT (US); Ken Scherzinger, Colchester, VT (US)

(21) Appl. No.: 19/366,730

(22) Filed: Oct. 23, 2025

Related U.S. Application Data
(60) Provisional application No. 63/715,351, filed on Nov. 1, 2024.

(51) Int. Cl. H01B 3/30; H01B 7/02; H01B 7/18; H01B 11/10; H01B 19/04

(52) U.S. Cl. CPC H01B 3/307; H01B 7/0216; H01B 7/1865; H01B 7/1875; H01B 11/10; H01B 19/04

(57) ABSTRACT

A cable capable of communicating large amounts of data while withstanding high heat conditions without the need for PFAS substances. The cable includes conductors encompassed by insulation. The insulation may include a non-PFAS fluoropolymer or materials such as polymethyl pentene or crosslinked polyalkene. The insulation may be encapsulated by a bedding layer, a shielding layer, a braid layer and a jacket. The insulation is designed to withstand temperatures of at least 125 degrees Celsius to ensure a high throughput of data even in demanding conditions.

### CROSS-REFERENCE TO RELATED APPLICATIONS AND PRIORITY

This patent application claims priority from U.S. Provisional Ser. No. 63/715,351 filed Nov. 1, 2024. This patent application us herein incorporated by reference in its entirety.

### FIELD OF THE DISCLOSURE

The present disclosure relates to communication cables and, more particularly, to cables used for data communication in high heat environments.

### BACKGROUND

Modern computer systems have continuously increasing demands for data. These increasing data demands are becoming ever more present in computer systems used in motor vehicles. The motor vehicle industry has typically relied on CAN bus cables for data transfer within a motor vehicle computer system, but those cables are not capable of handling the data demands of high-bandwidth low-latency applications which are becoming common in modern and upcoming motor vehicle computer systems (e.g., autonomous driving, infotainment, telematics).

The Institute of Electrical and Electronics engineers (IEEE) and the Society of Automotive Engineers (SAE) have indicated that Ethernet, the universal networking standard used in buildings, will become the new networking protocol for the motor vehicle industry. Unfortunately, the materials used in previously known Ethernet cables are not capable of withstanding the environmental conditions of the interior of a motor vehicle while the vehicle is in use or are spurring regulatory concerns over adverse health impacts. Thus, what is needed are new types of communication cables (including, but not limited to Ethernet cables) capable of meeting the data demands of modern vehicle computer systems as well as withstanding the environmental conditions of a motor vehicle while reducing or eliminating harmful substances contained within the communication cable.

### SUMMARY

The use of fluoropolymers for high-speed data communications is well known. With new regulatory concerns and challenges arising in response to the use of per-and poly fluoroalkyl substances (“PFAS”), fluoropolymers which are suitable for high-speed data communications but do not contain PFAS substances or limit PFAS substances are made more desirable. The present disclosure provides compositions of high-speed data cables which are insulated without using PFAS materials or limited PFAS materials and which may be durable enough for use in motor vehicles.

According to one embodiment of the present disclosure, a data communication cable is provided for addressing the above issues. The cable includes one or more conductors, as well as an insulating layer disposed over the conductors. The insulating layer is less than 95% weight-over-weight (“w/w”) of a fluoropolymer and contains limited or no per-and polyfluoroalkyl substances.

The insulating layer may comprise a number of different materials and forms. Some embodiments of the insulating layer may comprise less than 95% fluoropolymer insulation.

In some embodiments where the insulating layer comprises less than 95% fluoropolymer insulation, the fluoropolymer may be embodied as solid insulation.

In some other embodiments where the insulating layer comprises less than 95% fluoropolymer insulation, the fluoropolymer may be embodied as a foam.

In some embodiments where the insulating layer is embodied as a fluoropolymer foam, the insulating layer may further include a thin skin layer of solid insulation. When present, such a skin layer may be disposed on the exterior of the insulating layer, such that the foam is disposed between the conductors and the skin layer.

The data communication cable may also comprise one or more other components.

In some embodiments, the data communication cable may include a layer of conductive shielding. Such a shielding may consist of metal cladding or metal tubing. Adding shielding to a data communication cable may improve the durability of the cable in challenging environments where the cable may be exposed to physical or thermal abuse.

In some other embodiments, the data communication cable may include a filler material. Such a filler material may provide resistance to physical abuse or harmful temperatures.

In some other embodiments, the data communication cable may include an outer cable jacket. Such a jacket may be comprised of a low smoke zero halogen material, as an example. Adding a jacket to a data communication cable may improve the cable by shielding the cable from physical abuse.

The data communication cable may be configured to be disposed within a vehicle. A vehicle may mean an automobile, boat, airplane, train, or any other vehicle which may be used to transport people or cargo. A cable may be configured for use in a vehicle both by its data-carrying capacity and by its adaptation to the environmental conditions of a motor vehicle.

As motor vehicles become ever more reliant on software, cameras, sensors, and processors, the ability for the motor vehicle to move data at near instantaneous speeds becomes ever more critical. A second delay could be the difference in an accident with another vehicle or a pedestrian. A cable's data-carrying capacity will clearly affect its suitability for use in motor vehicles.

A cable's environmental adaptation may affect its suitability for use in motor vehicles. Sitting in the hot sun can drive the temperature inside of vehicles to temperatures that are hazardous for life. The temperature can be even greater near the engine of a motor vehicle. A data-carrying cable that becomes unreliable in elevated temperatures for its purpose poses a risk to everyone relying on safe operation of the motor vehicle.

In use, the conductor in a data communications cable may become heated by the volume of charge flowing through it or by external heating (such as engine or battery). Data cables may be rated to operate at different maximum temperatures depending on the materials used for the conductor and the insulation. Such temperatures may be 65, 70, 75, 80, or 90 degrees Celsius.

Different conductor materials may be preferred when operating at different temperatures. Conductors may be formed from copper, silver, aluminum, or alloys of these with or with coatings and other metals including multiple layers such as copper covered steel and copper covered aluminum.

In some embodiments, the cable may be configured to operate at substantially similar efficiency to maximum, even when the conductor is heated beyond the normal operating temperature of a communications cable. The cable may be designed to operate at or above 100,110, 120, 125 or 150 degrees Celsius.

In some embodiments, the cable's insulation may be formed from more than one layer. This multi-layered insulation may be multiple layers of the same material, or layers of varying materials. In those embodiments, the existing fluoropolymer layer may be considered the first layer, with a second layer formed from fluoropolymer, polymethyl pentene, crosslinked polyalkene (“XLPA”), or another insulative or non-insulative material understood by one skilled in the art.

According to another embodiment, a data communication cable is provided which includes one or more conductors, as well as an insulating layer disposed over the conductors. In this embodiment, the insulating layer may comprise polymethyl pentene, and compromises no PFAS.

The polymethyl pentene may be embodied in the form of a solid insulation. The polymethyl pentene may also be embodied in the form of a foam. When the polymethyl pentene is embodied in the form of a foam, the insulation may further comprise a thin skin layer of solid insulation. When present, such a skin layer may be disposed on the exterior of the insulating layer, such that the polymethyl pentene foam is disposed between the conductors and the skin layer.

According to yet another embodiment, a data communication cable is provided which includes one or more conductors, as well as an insulating layer disposed over the conductors. In this embodiment, the insulating layer may comprise XLPA, and comprises no PFAS.

In forming the XLPA, the polyalkene may be crosslinked by varied methods. One method for crosslinking polyalkene is moisture curing. Another method for crosslinking polyalkene is the use of an electron beam. The XLPA may also be formed by performing both processes on polyalkene. Use of both methods to crosslink polyalkene results in better performance than polyalkene crosslinked by only one method or the other.

In some embodiments, the cable's insulation may be formed from more than one layer. In those embodiments, the XLPA may be considered the first layer. The second insulating layer may be formed from XLPA, polymethyl pentene or a fluoropolymer. Like the XLPA insulation in the first layer, the second insulating layer should also contain no PFAS.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 illustrates a schematic of cable 100.

FIG. 2 illustrates a cross-sectional view of cable 100 shown in FIG. 1.

FIG. 3 is a chart comparing the performance between a cable with an insulation made from 100% fluoropolymer and a cable with an insulation made from less than 95% w/w fluoropolymer.

FIG. 4 is a chart comparing the performance between a cable comprising FEP insulation, polymethyl pentene insulation and XLHDPE insulation at 125 degrees Celsius.

FIG. 5 is a chart comparing the performance between a cable comprising FEP insulation, polymethyl pentene insulation and XLHDPE insulation at 125 degrees Celsius over one month.

FIG. 6 is a chart comparing performance between FEP, polymethyl pentene and a crosslinked polyalkene based insulations after 3000 hours.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

### DETAILED DESCRIPTION

A data communication cable is generally disclosed. The data communication cable may be an Ethernet cable, or other suitable data communication cable as will be apparent in light of this disclosure. The data communication cable may include one or more conductors. An insulating layer may be disposed over the conductors. In some embodiments, the insulating layer may include less than 95% w/w of a fluoropolymer without any per-and polyfluoroalkyl substances. In other embodiments, the insulating layer may be free of any per-and polyfluoroalkyl (PFAS) substances. In still additional embodiments, the insulating layer may comprise no fluoropolymer materials. It will be understood that for the purposes of this disclosure, PFAS substances refer to a group of chemicals used to make fluoropolymer coatings and products that resist heat, oil, stains, grease, and water.

PFAS are widely used, long-lasting chemicals, components of which break down very slowly over time. Because of their widespread use and their persistence in the environment, many PFAS are found in the blood of people and animals all over the world and are present at low levels in a variety of food products and in the environment. PFAS can be found in water, air, fish and soil. Scientific studies have shown that exposure to some PFAS in the environment may be linked to harmful health effects in humans and animals. There are thousands of PFAS chemicals, and they are found in many different consumer, commercial and industrial products. The pervasiveness of PFAS creates challenges in understanding the potential human health and long-term environmental risks. One example of a PFAS type material used in cables is fluorinated ethylene propylene (“FEP”). FEP has always been thought of as the lowest loss material and is the classic material used for category cables.

In some places within the present disclosure, reference may be made to standards, such as methods of measurement, or standards governed by bodies such as the Institute of Electrical and Electronics Engineers Standards Association (IEEE SA), SAE International, the Internation Organization for Standardization (ISO) and/or the OPEN Alliance. It should be noted that such standards may be revised from time to time and, accordingly, this disclosure should be read in conjunction with the most recent published standards as of the time of filing. An example of a standard, in accordance with some embodiments of the present disclosure, may be the IEEE 802.3 defining the physical layer and data link layer's media access control of wired Ethernet. In further examples, the standards may be SAE J3117/2 (202209) or SAE J3117/3. Other suitable standards may be apparent in light of this disclosure.

Additionally, in some places within the present disclosure, reference may be made to abbreviations of terms of art. A brief, and non-exhaustive, list of the present terms and/or abbreviations include fluorinated ethylene propylene (“FEP”), perfluoroalkoxy (“PFA”), cross-linked polyethylene plastic (“XLPE”) and cross-linked polyalkene (“XLPA”).

The present disclosure may also reference embodiments surviving or otherwise withstanding certain temperatures. When data cables are heated, the heating typically coincides with an increase in resistance within the cable, which decreases the signal strength. This is known as data loss. When embodiments discuss surviving or otherwise withstanding certain temperatures, it generally relates to maintaining data transmission at certain high temperatures such that the data loss is limited. In other examples, it may also relate to the cable itself being able to withstand and not degrade at certain temperatures. Generally, the present disclosure is aimed towards disclosing various materials which insulate the conductive material within a data cable to ensure the retention of data transmission.

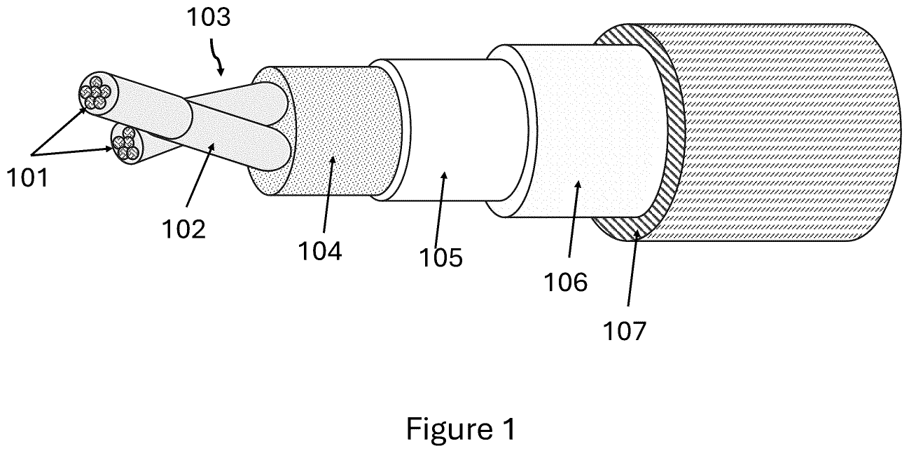

FIG. 1 illustrates cable 100 in accordance with some embodiments of the present disclosure. As can be seen, cable 100 may include one or more constituent elements. The constituent elements may include one or more conductors 101 and one or more layers of insulation 102. Cable 100 may also optionally include, as depicted in FIG. 1, one or more bedding layers 104, one or more shielding layers 105, one or more braid layers 106, and one or more jackets 107 in accordance with some embodiments. In some other embodiments, cable 100 may comprise a limited combination of constituent elements (i.e., conductor(s) 101, insulation 102, bedding layer(s) 104, shielding layer(s) 105, braid layer(s) 106, and jacket(s) 107) thereof. For example, cable 100 may, independent of the presence of other constituent elements, be shielded or unshielded, contain a bedding layer or lack a bedding layer and contain a jacket or lack a jacket. Each of these various constituent elements is discussed in turn below. More generally, FIG. 1 illustrates cable 100 comprising various constituent elements and their respective interrelationships.

In accordance with some embodiments, the constituent elements of cable 100 may have a specified order in which the constituent elements are configured to surround conductor(s) 101. In some embodiments, for example and as depicted in FIG. 1, conductor(s) 101 may be configured to be surrounded by insulation 102. In some additional embodiments, bedding layer(s) 104 may be configured to surround insultation 102. After, in some additional embodiments, shielding layer(s) 105 may be configured to surround bedding layer(s) 104. Additionally, in still some more embodiments, braid layer(s) 106 may be configured to surround shielding layer(s) 105. Lastly, and in accordance with some embodiments, jacket(s) 107 may be configured to surround braid layer(s) 106. In some other embodiments, the constituent elements of cable 100 may not have the aforementioned specified order in which the constituent elements make up cable 100.

In accordance with some embodiments, and as shown in FIG. 1, cable 100 may be a twisted pair cable. For example, cable 100 may include a plurality of conductor(s) and a plurality of insulation(s) configured to envelope the plurality of conductor(s). More specifically, one or more conducting elements, forming conductor(s) 101, may be disposed within insulation 102. The combination of conductor(s) 101 and insulation 102 create an inner cable 103. Inner cable 103 may then be twisted around a second inner cable forming a twisted pair of inner cables. The twisted pair of inner cables, in turn, may be encased within one or more of the following: the bedding layer(s), the shielding layer(s), and the jacket(s). In accordance with some embodiments, cable 100 may have more than one twisted pair of inner cables. Additionally, in accordance with some other embodiments, cable 100 may be a single conductor cable, or an untwisted balanced pair cable.

In accordance with some embodiments, conductor(s) 101 may be formed from a conductive material. In some embodiments, the conductive materials may be elemental metals, alloys, or a combination thereof. More specifically, and in accordance with some embodiments, the conductive material may be copper. Moreover, different conductor materials may be preferred when operating at different temperatures. Conductors may be formed from copper, silver, aluminum, or alloys of these with or with coatings and other metals including multiple layers such as copper covered steel and copper covered aluminum.

According to some embodiments, insulation 102 may be made from a material that is less than 95 percent w/w fluoropolymer. For example, insulation 102 may be derived from a fluorofoam comprising less than 95 percent w/w fluoropolymer. In some embodiments, for example, the fluorofoam may be foamed by heat of extrusion. In some other embodiments, insulation 102 may be a solid insulation. For example, insulation 102 may be extruded without being foamed to produce a solid insulation. In some additional embodiments, insulation 102 may be a foam insulation made from a less than 95 percent w/w fluoropolymer foam. To these ends, and in accordance with another embodiment, the fluoropolymer foam insulation may be a product of gas injection. Additionally, the fluoropolymer foam insulation, in accordance with some embodiments, may contain a fluoropolymer skin, or a thin extrusion, over the insulation. In further embodiments, the solid skin may be less than 95 percent w/w fluoropolymer. In accordance with another embodiment, the fluoropolymer foam may also be a product of chemical foam production process. As such, the fluoropolymer foam may also contain a fluoropolymer skin that is less than 95 percent w/w fluoropolymer, in accordance with some embodiments.

In accordance with some embodiments, insulation 102 may also be comprised of materials lacking PFAS substances. For example, insulation 102 may be or include materials such as polymethyl pentene. In accordance with some embodiments, the polymethyl pentene may be a product of gas injection with or without a nucleating agent. In some other embodiments, the polymethyl pentene may be made with or without a skin. In still some other embodiments, the polymethyl pentene may be a product of chemical foam production process with or without a skin. For example, in some embodiments where the polymethyl pentene is a product of a chemical foam production, the polymethyl pentene may be a chemical foam polymethyl pentene. In these embodiments, the production process may include adding a nucleating agent and foaming using gas injection.

In accordance with some embodiments, insulation 102 may be an alloy including polymethyl pentene and a different insulative or non-insulative material. Other suitable materials lacking PFAS substances will depend on a given target application or end-use and will be apparent in light of this disclosure. Moreover, other suitable methods for producing the skin may depend on a given target application or end-use and will also be apparent in light of this disclosure.

In some other embodiments, insulation 102 may be or include a crosslinked polyalkene (“XLPA”) material. In accordance with some embodiments, the XLPA material may employ multiple crosslinking methods to produce suitable characteristics within the XLPA material. For example, and in accordance with some embodiments, a cross-linking method may include a moisture cure production method. In another example, the cross-linking method may employ the use of an electron beam production method. In a third example, the cross-linking method may employ both the moisture cure and electron beam production methods. In accordance with some embodiments, the suitable characteristics may include surviving temperatures at 125 degrees Celsius. In accordance with some embodiments, the XLPA may be a product of gas injection production method, with or without a skin. In additional embodiments, the XLPA may be a product of a chemical foam production method, with or without a skin.

In accordance with some embodiments, insulation 102 may be or include cross-linked high-density polyethylene and/or XLPA. For example, in some embodiments, insulation 102 may include only cross-linked high-density polyethylene (“XLHDPE”). In other embodiments, insulation 102 may include only cross-linked high-density XLPA (“XLHDPA”). Still, in other embodiments, insulation 102 may include both cross-linked high-density polyethylene and cross-linked high-density XLPA. In accordance with some embodiments, the cross-linked high-density polyethylene and/or XLPA may be a product of gas injection production method, with or without a skin. In accordance with some other embodiments, the cross-linked high-density polyethylene and/or XLPA may be a product of a chemical foam production method, with or without a skin.

In accordance with some other embodiments, insulation 102 may comprise a color layer. In some embodiments the color layer may comprise a fluoropolymer material. For example, the fluoropolymer color layer may make up about 3% to 5% w/w of insulation 102. In some other embodiments, the color layer may comprise materials such as polymethyl pentene. In such embodiments, the total fluoropolymer composition of insulation layer 102 may be zero percent. In other suitable embodiments, the color layer may comprise materials other than polymethyl pentene and comprising zero percent fluoropolymer materials. Other suitable materials for the color layer may depend on a given target application or end-use and will also be apparent in light of this disclosure.

In accordance with some embodiments, cable 100 may include a plurality of layers of insulation 102. For example, in some embodiments, cable 100 may include two layers of insulation 102. In additional embodiments, cable 100 may include more than two layers of insulation 102. In accordance with some embodiments, one or more of the plurality of layers of insulation may include one of a moisture cured XLPA, a fluoropolymer and a polymethyl pentene. For example, two layers of insulation of the plurality of layers may include the moisture cured XLPA and the fluoropolymer. In another example, two layers of insulation of the plurality of layers may include the moisture cured XLPA and the polymethyl pentene. In yet another example, two layers of insulation of the plurality of layers may include the fluoropolymer and the polymethyl pentene. Other suitable composition combinations of the layers of insulation 102 may be apparent in light of this disclosure.

In accordance with some embodiments, insulation 102 may be an alloy. For example, in some embodiments, the alloy may include a polymethyl pentene and a fluoropolymer. Other suitable alloys may be apparent in light of this disclosure.

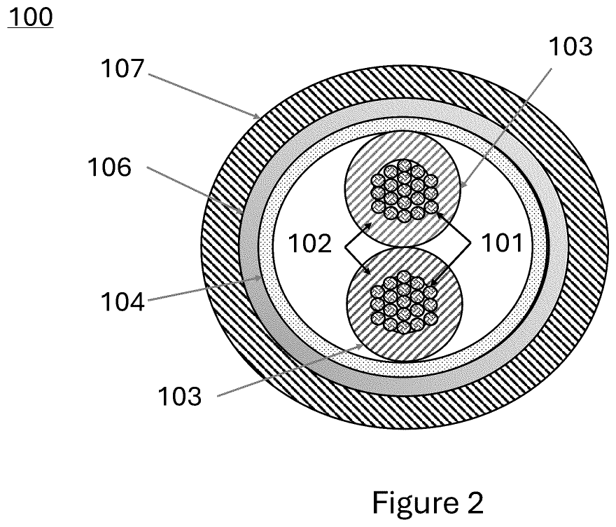

FIG. 2 shows a cross-sectional view of an embodiment of cable 100. As can be seen from FIG. 2, and in accordance with some embodiments, conductors 101 are fully enveloped in insulation 102. In other embodiments, conductors 101 may be partially enveloped in insulation 102. Continuing with the embodiment shown in FIG. 2, inner cable 103 may include multiple conductors 101 and insulation 102. According to some embodiments, inner cable 102 may substantially abut another twisted pair of inner cables. In some other embodiments, inner cable may not abut another twisted pair of inner cables. According to an embodiment, cable 100 may only contain one inner cable 103. Continuing with the embodiment shown in FIG. 2, the two inner cables are surrounded by bedding layer 104. In some other embodiments, bedding layer 104 may only partially surround the two inner cables. In FIG. 2, bedding layer 104 is surrounded by braid layer 106, which is in turn encapsulated by jacket 107. According to some other embodiments, cable 100 may, independent of the presence of other layers, be shielded or unshielded, contain or lack a bedding layer and contain or lack a jacket. Other suitable number of layers, such as having more than one insulation 102 layer, bedding layer 104, braid layer 106 or jackets 107 may be apparent in light of this disclosure.

According to some embodiments, cable 100 may be used for automotive purposes. According to some other embodiments, cable 100 may be used for autonomous vehicles, drones, self-driving boats, trains, planes, mining machines, construction equipment, and other industrial or commercial activities requiring both high speed data communication and durability. In some embodiments, insulation 102 may provide suitable data communication speeds through cable 100 at temperatures up to 125 degrees Celsius. In other embodiments, insulation 102 may provide suitable data communications at temperatures at or greater than 125 degrees Celsius. For example, in accordance with some embodiments, suitable data communications at temperatures up to or greater than 125 degrees Celsius may be achieved with or without a jacket 107.

According to some embodiments, and in accordance with some aforementioned standards organizations, cable 100 may provide suitable data communications at the rated temperature (e.g., 125 degrees Celsius) after 3000 hours. In another example, cable 100 may provide suitable data communications after 3000 hours of being heated to the rated temperature and cooled to room temperature. Other suitable milestones according to the standards organizations may be apparent in light of this disclosure.

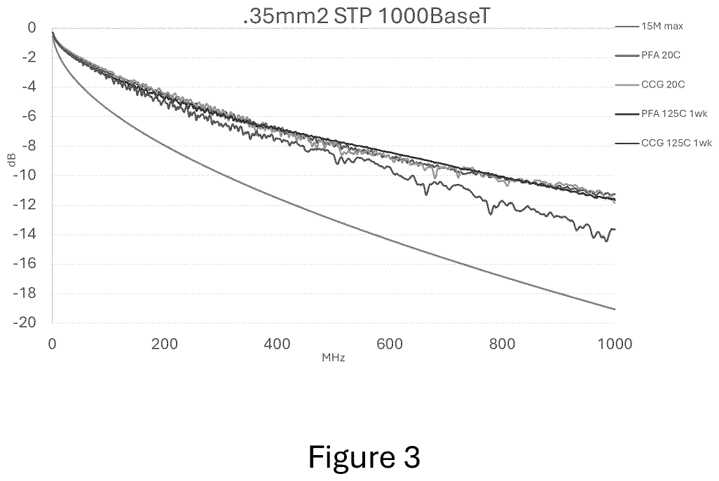

FIG. 3 shows a chart comparing the performance between cables with insulation comprising 100 % w/w fluoropolymer and cables, in accordance with some embodiments of the present disclosure, comprising less than 95% w/w of a fluoropolymer. Specifically, the chart compares a cable with insulation made from 100% w/w PFA to cable 100 with insulation 102 comprising 95% w/w of a fluoropolymer. As can be seen from the chart, cable 100 with insulation 102 comprising 95% w/w of a fluoropolymer performed within the passing specification requirements of the IEEE.

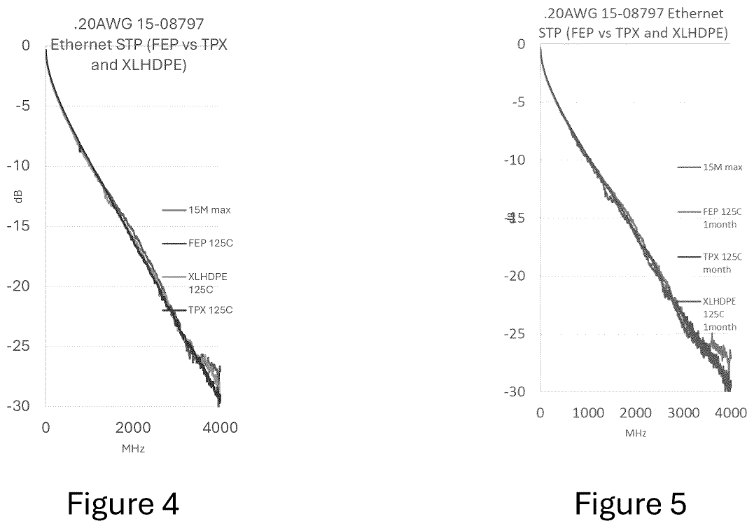

FIG. 4 shows a chart comparing the performance between cables with insulation comprising 100% w/w fluoropolymer and cables, in accordance with some embodiments of the present disclosure, comprising TPX and/or XLHDPE. Specifically, the chart shows the performance of the insulation when heated to 125 degrees Celsius. As can be seen from the chart, TPX and XLHDPE performed just as well as the insulation comprising 100% w/w fluoropolymer.

FIG. 5 shows a chart comparing the performance between cables with insulation comprising 100 % w/w fluoropolymer and cables, in accordance with some embodiments of the present disclosure, comprising TPX and/or XLHDPE. Specifically, the chart shows the performance of the insulation when heated to 125 degrees Celsius for a one-month period. Again, as can be seen from the chart, TPX and XLHDPE performed just as well as the insulation comprising 100% w/w fluoropolymer over a one-month period.

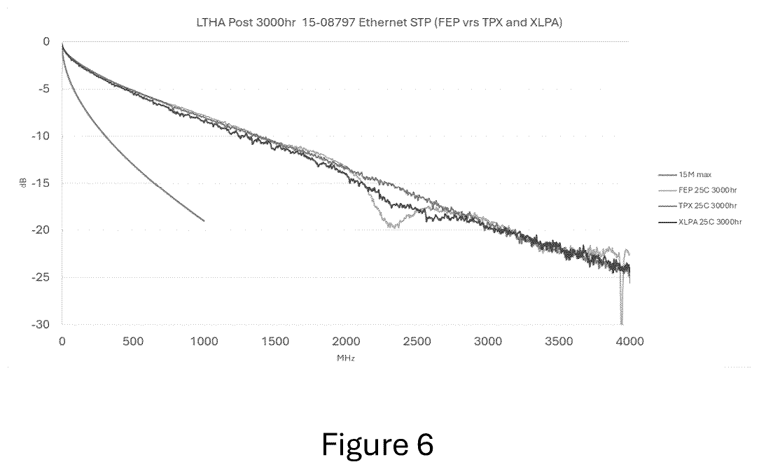

FIG. 6 shows a chart comparing the performance between FEP, polymethyl pentene and a crosslinked polyalkene based insulations. It is known that FEP and PFA outperform XLPE for losses in a data cable. However, as shown in FIG. 6, both an embodiment of cable 100 comprising a polymethyl pentene insulation 102 and another embodiment of cable 100 comprising a XLPA insulation 102 outperformed the FEP after 3000 hours of testing at 125 degrees Celsius.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description. Future-filed applications claiming priority to this application may claim the disclosed subject matter in a different manner and generally may include any set of one or more limitations as variously disclosed or otherwise demonstrated herein.

1. A data communication cable, comprising:
at least one conductor; and
an insulating layer disposed over the at least one conductor, wherein the insulating layer comprises less than 95% w/w of a fluoropolymer, and is void of PFAS (Per-and polyfluoroalkyl substances).

2. The cable of claim 1, wherein the insulating layer comprises a solid insulation.

3. The cable of claim 1, wherein the insulating layer comprises a chemical foam insulation.

4. The cable of claim 3, wherein the insulating layer further comprises a solid skin layer of insulation disposed on the chemical foam such that the chemical foam is disposed between the at least one conductor and the solid skin layer.

5. The cable of claim 1, further comprising an inner layer of conductive shielding surrounding the conductors.

6. The cable of claim 1, further comprising a filler material disposed within the cable.

7. The cable of claim 1, further comprising an outer cable jacket surrounding the insulating layer.

8. The cable of claim 1, wherein the cable is configured to be disposed within an electric system of a vehicle.

9. The cable of claim 1, wherein the cable is configured to operate at substantially maximum efficiency when the conductor is heated to 125 C.

10. The cable of claim 1, further comprising a second insulating layer.

11. The cable of claim 10, wherein the second insulating layer comprises polymethyl pentene.

12. The cable of claim 10, wherein the second insulating layer comprises crosslinked polyalkene.

13. A data communication cable, comprising:
one or more conductors
an insulating layer disposed over the conductors, wherein the insulating layer comprises polymethyl pentene, and is void of PFAS.

14. The cable of claim 13, wherein the insulating layer comprises polymethyl pentene foam.

15. The cable of claim 14, wherein the insulating layer further comprises a solid skin layer of insulation disposed on the polymethyl pentene foam such that the polymethyl pentene foam is disposed between the one or more conductors and solid skin layer.

16. A data communication cable, comprising:
one or more conductors; and
an insulating layer disposed over the conductors, wherein the insulating layer comprises crosslinked polyalkene, and is void of PFAS.

17. The cable of claim 16, wherein the crosslinked polyalkene is crosslinked by at least one of:
moisture curing; and
electron beam curing.

18. The cable of claim 16, wherein the crosslinked polyalkene is crosslinked by both moisture curing and electron beam curing.

19. The cable of claim 16, further comprising a second insulating layer.

20. The cable of claim 19, wherein the second insulating layer comprises at least one of:
polymethyl pentene and a fluoropolymer.
